(19) United States
(12) Patent Application Publication
(10) Pub. No.: US 2010/0238006 A1
(43) Pub. Date: Sep. 23, 2010

(54) CONCEALED DISPLAY FOR AN EXTERNAL SURFACE OF A VEHICLE

(75) Inventors: Duane M. Grider, Farmington Hills, MI (US); Bala Chander, Canton, MI (US); Allan Roy Gale, Livonia, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/405,314

(22) Filed: Mar. 17, 2009

(51) Int. Cl. B60Q 1/00; G09G 3/32; G09G 3/36; G06F 3/041; G08B 21/00

(52) U.S. Cl. 340/425.5; 345/82; 345/87; 345/173; 340/636.1

(57) ABSTRACT

A panel assembly includes a body that is attachable to a vehicle and has an aperture. A display sub-assembly configured for illumination has a periphery configured to conform to the aperture. The display sub-assembly is mounted to the body within the aperture such that a surface of the display sub-assembly and a surface of the body are substantially flush. A translucent coating is disposed over both the surface of the body and the surface of the display sub-assembly. The translucent coating substantially conceals the display sub-assembly.

### BACKGROUND

1. Technical Field

Embodiments of the invention disclosed herein relate to providing a body panel for use as an external surface of a vehicle, the body panel including a display sub-assembly providing information relating to a system of the vehicle. The body panel and the display sub-assembly together appear to form a contiguous, uninterrupted surface and the display is concealed until illuminated.

2. Background Art

Hybrid electric vehicles have become commonplace in today's automotive market and plug-in hybrid electric vehicles and electric vehicles operating solely on battery power are either currently available or will be entering the marketplace in the foreseeable future. Plug-in hybrid electric vehicles and electric vehicles include an electric charging system having a rechargeable battery.

During the recharging of plug-in hybrid electric vehicles and plug-in electric vehicles, it is anticipated that a vehicle user, while situated outside the vehicle, will need information pertaining to the state of the electric charging system including, but not limited to, information pertaining to the state of charge of the battery. For example, before operating a vehicle that has been on-plug (a state wherein the electric charging system of the vehicle is connected to an external power source) for some period of time, the user may wish to ascertain the state of charge of the battery and may wish to do so before conceal a display sub-assembly that is configured to provide such information. This may be for aesthetic reasons or simply to avoid passers-by accessing the display which may result in the dissipation of some of the electric energy stored in the rechargeable battery.

Embodiments of the present invention address this and other problems.

### SUMMARY

Various embodiments of a panel assembly for use with a vehicle are disclosed herein. In a first embodiment, the panel assembly comprises a body having an aperture. The panel assembly further comprises a display sub-assembly mounted within the aperture. A periphery of the display sub-assembly generally conforms to the aperture. A surface of the display sub-assembly is substantially flush with a surface of the body. The panel assembly further comprises a translucent coating disposed over both the surface of the body and the surface of the display sub-assembly to substantially conceal the display sub-assembly.

In an implementation of the first embodiment, the translucent coating generally permits light emanating from the display sub-assembly to be transmitted through the translucent coating. The translucent coating generally reflects light emanating from a source external to the body.

In another implementation of the first embodiment, the surface of the display sub-assembly is substantially invisible from a position external to the body when the display sub-assembly is not illuminated. The surface of the display sub-assembly is substantially visible from a position external to the body when the display sub-assembly is illuminated.

In another implementation of the first embodiment, a color of the translucent coating that is disposed over the surface of the display sub-assembly is substantially the same as a color of the translucent coating that is disposed over the surface of the body such that the surface of the body and the surface of the display sub-assembly together appear to form an uninterrupted and contiguous surface when the display sub-assembly is not illuminated.

In another implementation of the first embodiment, the body comprises an A-pillar or a C-pillar of the vehicle.

In another implementation of the first embodiment, the body comprises a front quarter panel or a rear quarter panel of the vehicle.

In another implementation of the first embodiment, the display sub-assembly comprises a light emitting diode.

In another implementation of the first embodiment, the display sub-assembly comprises a liquid crystal display.

In a second embodiment, a panel assembly comprises a body that is configured to be attached to a plug-in hybrid electric vehicle. The body comprises an outer surface of the plug-in hybrid electric vehicle. The body has an aperture defined therein. The panel assembly further comprises a display sub-assembly configured for illumination wherein the illumination corresponds to a status of an electric charging system of the plug-in hybrid electric vehicle. The display sub-assembly has a periphery that is configured to generally conform to the aperture. The display sub-assembly is mounted to the body such that the periphery is disposed within the aperture and such that a surface of the display sub-assembly is substantially flush with a surface of the body. The panel assembly further comprises the translucent coating that is disposed over both the surface of the body and the surface of the display sub-assembly.

In an implementation of the second embodiment, the translucent coating generally permits light emanating from the display sub-assembly to be transmitted through the translucent coating. The translucent coating generally reflects light emanating from a source external to the body.

In another implementation of the second embodiment, the display sub-assembly includes a thermal detector. The display sub-assembly is further configured to illuminate in response to the thermal detector detecting the presence of a predefined thermal signal.

In another implementation of the second embodiment, the display sub-assembly includes a motion detector. The display sub-assembly is further configured to illuminate in response to the motion detector detecting motion proximate the display sub-assembly.

In another implementation of the second embodiment, the display sub-assembly includes a touch sensor. The display sub-assembly is further configured to illuminate in response to a user touching the display sub-assembly. In a variation of this implementation, the touch sensor may employ a resistive, a capacitative, or a stray capacitative method for detecting that the display sub-assembly has been touched.

In another implementation of the second embodiment, the display sub-assembly is further configured to display information corresponding to a state of charge of a rechargeable battery of the electric charging system. In a variation of this implementation, the display sub-assembly is further configured to display information corresponding to a length of time until charging the rechargeable battery is complete.

In another implementation of the second embodiment, the display sub-assembly is further configured to permit a user to enter information corresponding to the electric charging system. In a variation of this implementation, the display sub-assembly is further configured to permit a user to set a start time and a completion time for charging the electric charging system.

In another implementation of the second embodiment, the display sub-assembly is further configured to display and alert when the electric charging system detects a fault during electric charging.

In a third embodiment, a vehicle assembly having an electrical charging system is disclosed. The vehicle comprises a vehicle body. The vehicle assembly further comprises a body panel attached to the vehicle body. The body panel has an aperture that is defined therethrough. The vehicle assembly further comprises a display sub-assembly configured for illumination. The illumination corresponds to a status of the electric charging system. The display sub-assembly has a periphery that is configured to generally conform to the aperture. The display sub-assembly is mounted to the body panel such that the display sub-assembly is disposed within the aperture and a surface of the display sub-assembly is substantially flush with a surface of the body panel. The vehicle assembly further comprises a translucent paint disposed over both the surface of the body panel and the surface of the display sub-assembly.

### BRIEF DESCRIPTION OF THE DRAWINGS

FIG. 1 is a schematic view illustrating a vehicle having an electric charging system and an embodiment of the panel assembly of the present invention with the display sub-assembly illuminated to illustrate information corresponding to the electric charging system while the vehicle is being electrically charged;

FIG. 2 illustrates the vehicle of FIG. 1 with the display sub-assembly substantially concealed while in a non-illuminated state;

FIG. 3 is an exploded view of an embodiment of the panel assembly of the present invention;

FIG. 4 is a perspective view illustrating the panel assembly of FIG. 3 with the display sub-assembly positioned within the aperture of the body prior to application of a translucent coating;

FIG. 5 is a perspective view illustrating the panel assembly of FIG. 4 subsequent to the application of the translucent coating;

FIG. 6 is a cross-section taken along the lines 6-6 in FIG. 5;

FIG. 7 is a perspective view illustrating an alternate embodiment of a panel assembly made in accordance with the teachings of the present invention prior to initiating a charging cycle of the vehicle's electrical charging system;

FIG. 8 is a perspective view of the embodiment of the panel assembly illustrated in FIG. 7 during a charging cycle of the electrical charging system illustrating the display sub-assembly in an illuminated state;

FIG. 9 is a perspective view illustrating various methods of activating the display sub-assembly to illuminate; and

FIG. 10 is a perspective view illustrating the display sub-assembly of FIG. 9 subsequent to activation.

### DETAILED DESCRIPTION OF EMBODIMENTS OF THE INVENTION

Detailed embodiments of the present invention are disclosed herein; however, it is to be understood that the disclosed embodiments are merely exemplary of the invention that may be embodied in various and alternative forms. The figures are not necessarily drawn to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

As plug-in hybrid electric vehicles and other types of electric vehicles which are configured to receive an electric charge from a power source positioned external to the vehicle enter the marketplace, it is anticipated that a person charging the vehicle will want or need to receive information about the status of the electric charging system of the vehicle while positioned outside of the vehicle. It is further anticipated that providing a plainly visible display on an external surface of the vehicle may invite tampering with the display or other unwanted activation of the display and/or interaction with the electric charging system of the vehicle by persons other than vehicle operator. Additionally, it may be desirable to conceal or camouflage the display for aesthetic reasons. Such concealment permits a surface of the vehicle where the display is mounted to appear to be an uninterrupted, contiguous surface without any indication that the surface contains a display assembly.

Embodiments of the present invention address these problems by incorporating a display sub-assembly into a body panel of the vehicle such that a display surface of the display assembly is substantially flush with a surrounding surface of the body panel to which the display sub-assembly is attached and painting over the body panel and the display screen of the display sub-assembly such that the display sub-assembly and the body panel together appear to form an integral, contiguous and uninterrupted surface.

In some embodiments, the body panel may include an aperture for receiving the display sub-assembly. The display sub-assembly may be configured such that a periphery of the display sub-assembly substantially conforms to a periphery of the aperture both in terms of shape and size such that the display sub-assembly may snugly interlock with the aperture of the panel. To the extent that any gap remains between the periphery of the display sub-assembly and the periphery of the aperture, a gap filler, such as an epoxy or other substance may be provided to eliminate any discontinuity between the surface of the body panel surrounding the aperture and the surface of the display assembly disposed within the aperture to provide a smooth, substantially continuous surface.

A translucent coating, such as a paint may then be applied to a surface of the body panel and the display sub-assembly to provide the appearance of a continuous uninterrupted coated surface. In some embodiments, the translucent coating will have color and will permit light emanating from the display screen of the display sub-assembly to penetrate the translucent coating so as to be visible from a position proximate the panel. The translucent coating may also reflect light originating from a position outside the vehicle such that the display sub-assembly is substantially invisible when not illuminated.

In this manner, an automobile manufacturer is given great flexibility in positioning the display sub-assembly on an external surface of the vehicle. While it might be unsightly or aesthetically undesirable to place a conventional display assembly at certain locations around an external surface of the vehicle because of the visual discontinuity caused by a display sub-assembly, embodiments of the present invention allow a manufacturer to position a sub-assembly in virtually any exterior location on the vehicle because the display sub-assembly is concealed and causes no aesthetically displeasing appearance. For instance, while it might be undesirable to place a visible display sub-assembly on a rear quarter panel of a vehicle, using embodiments of the present invention will provide an apparently seamless rear quarter panel and thus eliminates the aesthetic concerns over locating the display sub-assembly there.

Embodiments of the present invention also obviate the need to provide a door or other access panel to cover the display sub-assembly because the translucent coating provides protection against the elements such as wind, rain and snow.

The display sub-assembly may be configured to permit the vehicle user to input data into the electrical charging system and also to retrieve information. For instance, a user of the vehicle may wish to confirm that the electrical charging system of the vehicle is receiving a charge when the electrical charging system is “on-plug”. As used herein, the term “on-plug” refers to the circumstance where the electrical charging system is connected to an external power source, such as through an extension cord connecting the electrical charging system to an electrical outlet of a household. Similarly, it may be desirable to know that there is fault that precludes the electrical charging system from receiving a charge when the electrical charging system is on-plug. The display sub-assembly can be configured to provide this information to a vehicle user. The display sub-assembly may also be configured to allow a user to set a start time and/or a completion time when charging the vehicle. The display sub-assembly may also be configured to inform a vehicle user as to the estimated completion time for charging the vehicle. The display sub-assembly may further be configured to provide information concerning the current state of charge of the rechargeable battery. The display sub-assembly may also be configured to provide information to a user concerning other systems on the vehicle such as an engine block heater.

A greater understanding of the embodiments of the present invention may be obtained through a review of the figures accompanying this application as well as a review of the detailed description provided below.

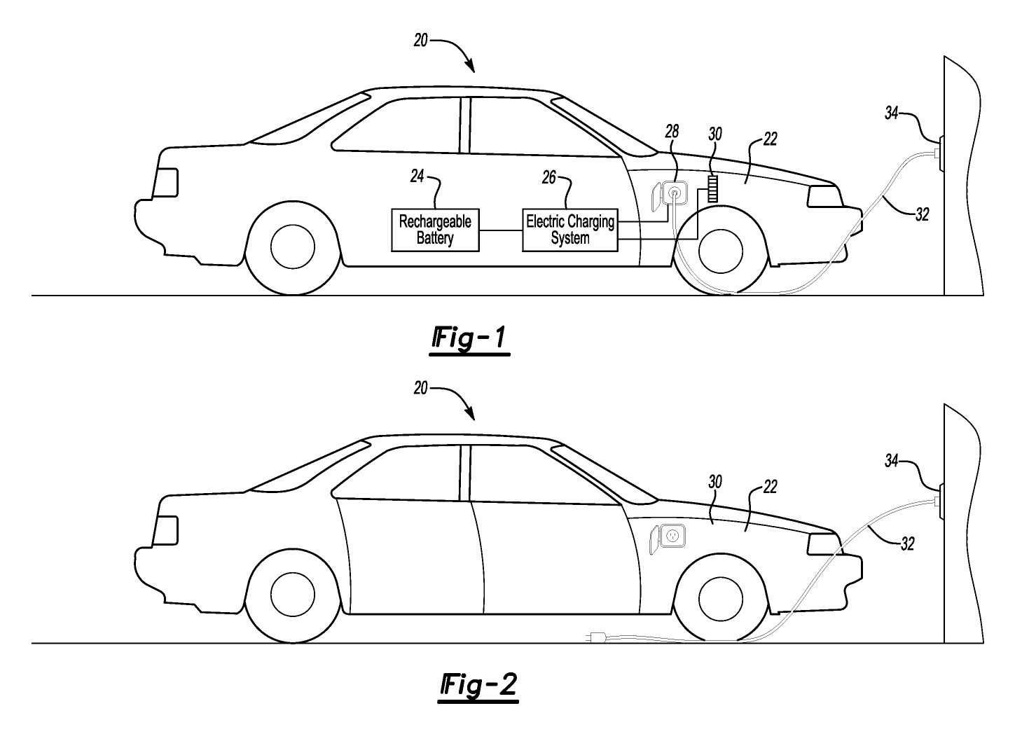

With respect to FIG. 1, an embodiment of a vehicle assembly 20 having an embodiment of a panel assembly 22 made in accordance with the teachings of the present invention is illustrated. Vehicle assembly 20 may be any type of automotive vehicle including, but not limited to, sport utility vehicles, pickup trucks, passenger sedans, coupes, minivans, full size vans, convertibles, motorcycles, golf carts, neighborhood electric vehicles and busses. The vehicle assembly 20 may have a hybrid electric propulsion system including an electric motor (not shown) powered by a rechargeable battery 24 and an internal combustion engine (not shown). Other embodiments of vehicle assembly 20 may comprise a pure electric vehicle having only an electric motor and a rechargeable battery 24. Vehicle assembly 20 includes an electric charging system 26 configured to receive electric energy through plug receptacle 28 and to direct the electrical energy to rechargeable battery 30. The electrical charging system may include a battery control module (not shown) which may be configured to monitor the state of charge of rechargeable battery 24 as rechargeable battery 24 is being recharged.

In the embodiment illustrated in FIG. 1, panel assembly 22 comprises a front quarter panel of vehicle assembly 20. It should be understood that the teachings of the present invention are compatible with any outer body panel of vehicle assembly 20 including rear quarter panels, A-pillars, B-pillars and C-pillars.

Panel assembly 22 includes a display sub-assembly 30 integrated therein. Display sub-assembly 30 is connected to the electrical charging system and is configured to illuminate and to display information relating to the electric charging system 26 and rechargeable battery 24. In other embodiments, display sub-assembly 30 may be configured to display information relating to other vehicle systems including an engine block heater (not shown).

In the illustrated embodiment, vehicle assembly 20 is depicted during a recharging cycle wherein plug receptacle 28 is electrically connected through an extension cord 32 to a standard household electrical outlet 34. In other embodiments, receptacle 28 may be electrically connected to any external charger or charging station. By connecting plug receptacle 28 to household electrical outlet 34, electrical charging system 26 receives electric energy and may commence a recharging cycle of rechargeable battery 24. Display sub-assembly 30 is illustrated in an illuminated state wherein a surface of display sub-assembly 30 displays information relating to the electrical charging system 26 and rechargeable battery 24.

In some embodiments, display sub-assembly 30 may remain illuminated throughout the entire period of time that vehicle assembly 20 is on-plug. In other embodiments, display sub-assembly 30 may illuminate for only a finite period of time after extension cord 32 is plugged into plug receptacle 28 (e.g., one minute) after which time display sub-assembly 30 may cease illumination.

With respect to FIG. 2, vehicle assembly 20 is depicted after a charging cycle of rechargeable battery 24 has ended and extension cord 30 has been unplugged from plug receptacle 28. In this figure, display sub-assembly 30 is not illuminated and, for that reason, is not visible. Rather, display sub-assembly 30 is concealed under translucent coating 36 (see FIG. 6).

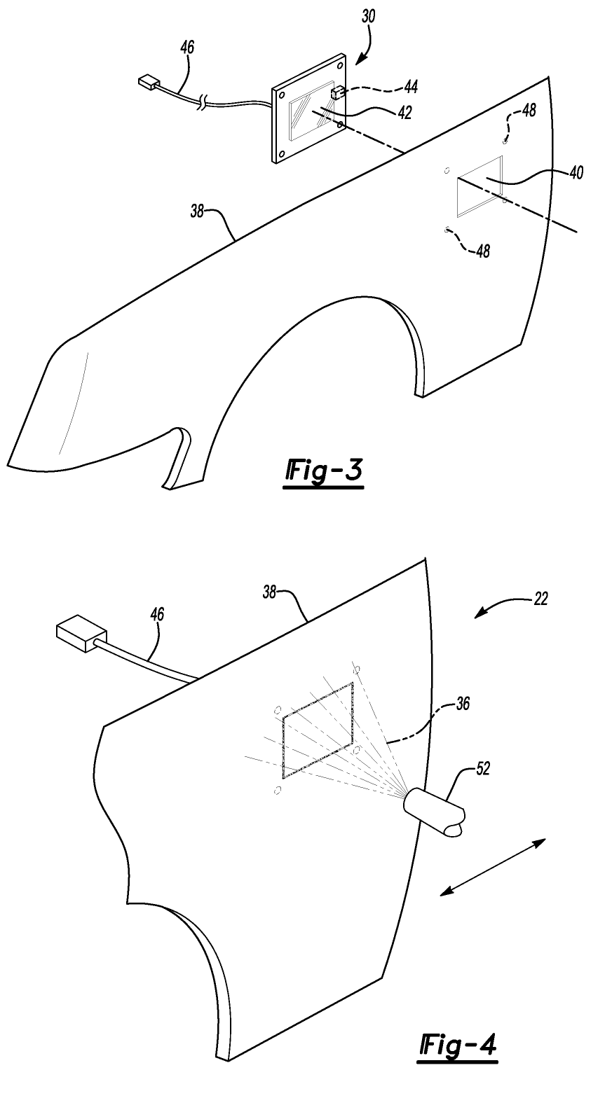

With respect to FIG. 3, an exploded view of panel assembly 22 is illustrated. Panel assembly 22 includes a body 38 shaped as a front quarter panel having an aperture 40 for receiving a portion of display sub-assembly 30. Display sub-assembly 30 includes a screen 42 which is a periphery that is contoured to substantially conform to a periphery of aperture 40 and is dimensioned slightly smaller so as to fit snugly therein. Display sub-assembly includes a detector sub-assembly which may be configured to detect attempts by a user to activate display sub-assembly 30 as discussed below. Display sub-assembly 30 further includes a connection cord 46 to enable display sub-assembly 30 to connect to, and to receive signals and other input from, electrical charging system 26. Body 38 includes a plurality of mounting apertures 48 which permit body 38 to be mounted to vehicle assembly 20, for example, through the use of mechanical fasteners. In other embodiments, body 38 may be welded to vehicle assembly 20 or otherwise attached by any method or means effective to substantially permanently affix body panel 22 to vehicle assembly 20.

With respect to FIG. 4, panel assembly 22 is illustrated immediately after display sub-assembly 30 has been assembled to body 38 such that screen 42 is disposed within aperture 40. Display sub-assembly 30 may be attached to body 38 through the use of mechanical means such as threaded fasteners, rivets, welding and any other method or means effective to substantially permanently affix display sub-assembly 30 to body 38. When display sub-assembly 30 is first assembled to body 38, a seam 50 may be visible between display sub-assembly and body 38. Seam 50 comprises a gap between a side wall of screen 42 and a wall of aperture 40 and may be filled in with an epoxy (which may secure display sub-assembly 30 to body 38) or with another substance. The use of an epoxy or other gap filling substance effectively eliminates seam 50 and creates a substantially continuous surface comprising a surface of screen 42, a surface of the epoxy or gap filling agent and a surface of body 38. Use of an epoxy or gap filler in this manner substantially physically eliminates seam 50.

Disposed above, panel assembly 22 is a spray head 52 dispensing, in liquid form, translucent coating 36. Translucent coating 36 comprise a paint, a clear coat, or any other substance effective to coat an outer surface of panel assembly 22. Translucent coating 36 may serve a plurality of purposes including substantially concealing screen 42 and protecting screen 42, display sub-assembly 30 and body 38 from the elements such as rain, snow, and sun.

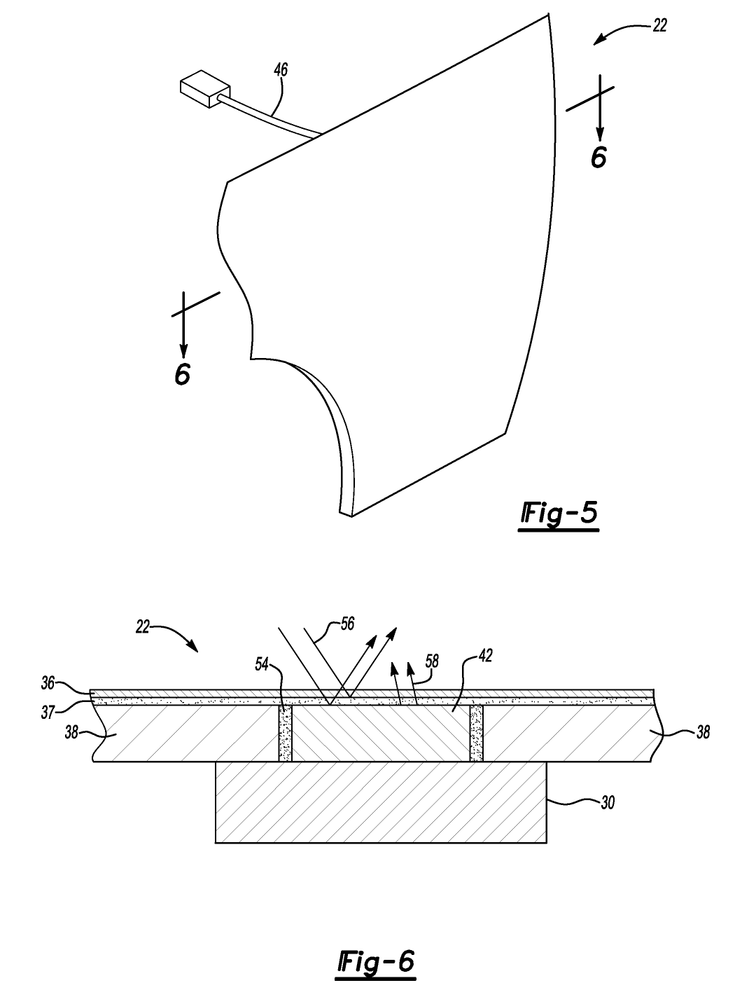

With respect to FIG. 5, panel assembly 22 is illustrated after spray head 52 has completed the application of translucent coating 36. Once translucent coating 36 is supplied to the surface of body 38 and screen 42, screen 42, when not illuminated, is substantially invisible from above panel assembly 22.

With respect to FIG. 6, a cross-section of panel assembly 22 is illustrated. In this illustration, display sub-assembly 30 is depicted with screen 42 nested within aperture 40 of body 38. A layer of epoxy 54 is illustrated disposed adjacent the periphery of screen 42 and aperture 40 to provide continuity between an upper surface of body 38 and an upper surface of screen 42, thus eliminating seam 50. Translucent coating 36 and, in this embodiment, an opaque layer 37, is disposed over an upper surface of body 38 and screen 42.

From above translucent coating 36, panel assembly 22 appears to have a seamless, and uninterrupted surface. In some embodiments, translucent coating 36 is configured to reflect light 56 originating from a source external to vehicle assembly 20 while permitting light 58 emanating from display sub-assembly 30 to pass through translucent coating 36. Examples of coatings 38 which may be used as translucent coating 36 include combinations of conventional thin opaque or semi-opaque base coating of color and then translucent or transparent clear coat over the base coat. In some embodiments, the conventional thin opaque or semi-opaque coatings of color may be omitted entirely and the translucent or transparent clear coat may be applied directly to the upper surface of the body 38 and the upper surface of screen 42. Application of these coatings may make the upper surface of body 38 and the upper surface of screen 42 appear opaque except when display sub-assembly 30 is illuminated. Light from the display sub-assembly 30 emanating from below the paint coatings discussed above passes through the paint coatings to become visible to the user.

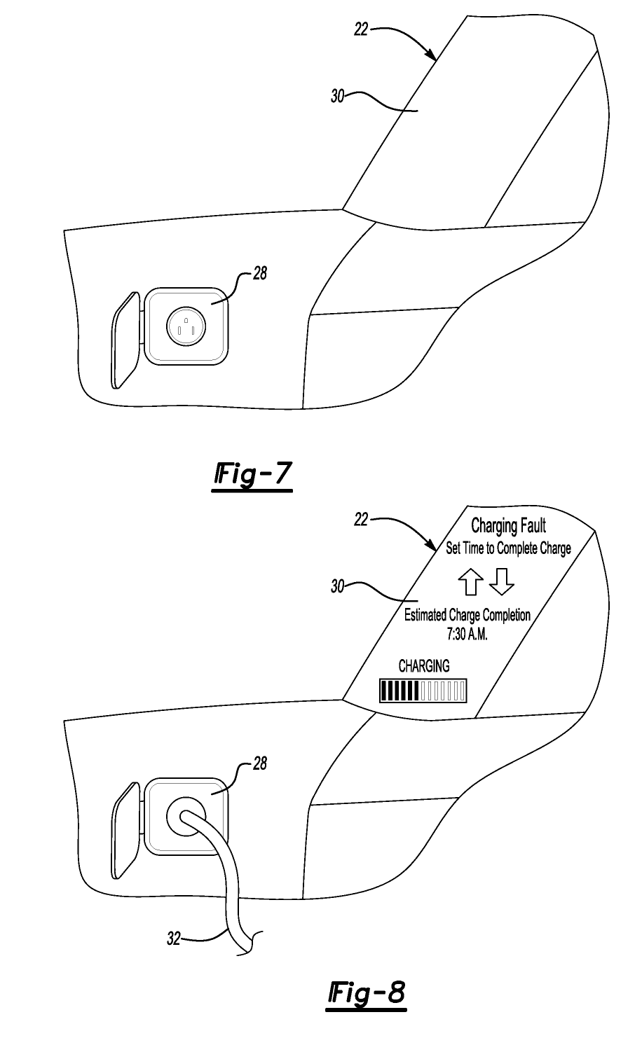

With respect to FIG. 7, an alternate embodiment of panel assembly 22 is illustrated. In FIG. 7, panel assembly 22 comprises an A-pillar of vehicle assembly 20. In FIG. 7, display sub-assembly 30 is not illuminated.

With respect to FIG. 8, extension cord 32 has been plugged into plug receptacle 28 and electrical charging system 26 (now shown) is receiving a charge. In this illustration, display sub-assembly 30 is illuminated. Display sub-assembly 30 may be configured to provide a variety of information to a vehicle user concerning the status of the electrical charging system 26 and rechargeable battery 28. For example, display sub-assembly 30 may indicate whether there is a fault that precludes electrically charging rechargeable battery 24. In some embodiment, display sub-assembly 30 may be configured to advise a user when the serviceable life of rechargeable battery 24 has ended or is nearing its end.

Display sub-assembly 30 may further be configured to receive input from the user using touch screen technology or other technologies that permit a user to interact with display sub-assembly 30. For example, display sub-assembly 30 may be configured to permit a user to set a time of day for charging to commence or to be completed. Display sub-assembly 30 may further be configured to estimate the amount of time remaining until completion of electric charge or may provide the time of day when it estimates that charging will be complete.

Display sub-assembly 30 may be configured to display a state of charge of rechargeable battery 24. In the illustrated embodiment, a plurality of solid and hollow bars are provided to indicate a general percentage of battery charge. In other embodiments, a digital readout may identify the precise percentage charge rechargeable battery 24 is currently holding. In still other embodiments, an analog display, for example, a speedometer having a needle may be used to convey information to the user about the state of charge of rechargeable battery 24.

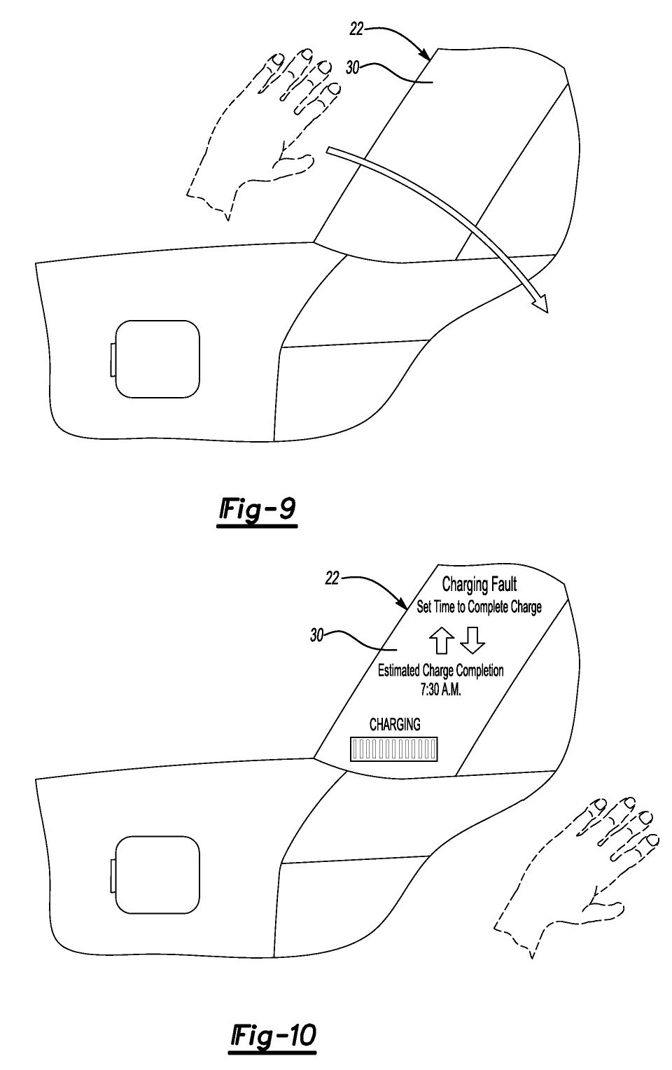

With respect to FIGS. 9 and 10, a user may require information about electrical charging system 26 and/or rechargeable battery 24 at times when vehicle assembly 20 is not on-plug. Display sub-assembly may be configured to display information about rechargeable battery 24 and electric charging system 26 when vehicle assembly 20 is not on-plug. Detector sub-assembly 44 (see FIG. 3) may be configured to detect motion proximate display sub-assembly 30. Alternatively, detector sub-assembly 44 may be configured to detect a thermal signal such as the heat given off by a hand when in close proximity to display sub-assembly 30. In still other embodiments, display sub-assembly 30 may include touch screen sensitivity such that an operator need only touch the screen 42 to activate illumination of display sub-assembly 30.

In some embodiments of panel assembly 22 and vehicle assembly 20, it may desirable to provide a security feature that prevents an unauthorized user from interacting with electrical charging system 26. Such embodiments may include a keypad (not shown) for the entry of a security code or a finger print reader to determine whether a user is authorized to interact with electrical charging system 26. Any other security feature effective to limit access to electrical charging system 26 may also be employed.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A panel assembly comprising:
a body having an aperture;
a display sub-assembly mounted within the aperture, a periphery of the display sub-assembly generally conforming to the aperture and a surface of the display sub-assembly being substantially flush with a surface of the body; and
a translucent coating disposed over both the surface of the body and the surface of the display sub-assembly to substantially conceal the display sub-assembly.

2. The panel assembly of claim 1 wherein the translucent coating generally permits light emanating from the display sub-assembly to be transmitted through the translucent coating and wherein the translucent coating generally reflects light emanating from a source external to the body.

3. The panel assembly of claim 1 wherein the surface of the display sub-assembly is substantially invisible from a position external to the body when the display sub-assembly is not illuminated and wherein the surface of the display sub-assembly is substantially visible from a position external to the body when the display sub-assembly is illuminated.

4. The panel assembly of claim 1 wherein a color of the translucent coating disposed over the surface of the display sub-assembly is substantially the same as a color of the translucent coating disposed over the surface of the body such that the surface of the body and the surface of the display sub-assembly together appear to form an uninterrupted and contiguous surface when the display sub-assembly is not illuminated.

5. The panel assembly of claim 1 wherein the body comprises an A-pillar or a C-pillar of the vehicle.

6. The panel assembly of claim 1 wherein the body comprises a front quarter panel or a rear quarter panel of the vehicle.

7. The panel assembly of claim 1 wherein the display sub-assembly comprises a light emitting diode.

8. The panel assembly of claim 1 wherein the display sub-assembly comprises a liquid crystal display.

9. A panel assembly comprising:
a body configured to be attached to a vehicle having an electric charging system, the body comprising an outer surface of the vehicle, and the body having an aperture defined therein;
a display sub-assembly configured for connection to the electric charging system, the display sub-assembly being further configured for illumination, the illumination corresponding to a status of an electric charging system of the plug-in hybrid electric vehicle, the display sub-assembly having a periphery configured to generally conform to the aperture, the display sub-assembly being mounted to the body such that the periphery is disposed within the aperture and such that a surface of the display sub-assembly is substantially flush with a surface of the body; and
a translucent coating disposed over both the surface of the body and the surface of the display sub-assembly, the translucent coating substantially concealing the display sub-assembly.

10. The panel assembly of claim 9 wherein the translucent coating generally permits light emanating from the display sub-assembly to be transmitted through the translucent coating and wherein the translucent coating generally reflects light emanating from a source external to the body.

11. The panel assembly of claim 9 wherein the display sub-assembly includes a thermal detector and wherein the display sub-assembly is further configured to illuminate in response to the thermal detector detecting the presence of a predefined thermal signal.

12. The panel assembly of claim 9 wherein the display sub-assembly includes a motion detector and wherein the display sub-assembly is further configured to illuminate in response to the motion detector detecting motion proximate the display sub-assembly.

13. The panel assembly of claim 9 wherein the display sub-assembly includes a touch sensor and wherein the display sub-assembly is further configured to illuminate in response to a user touching the display sub-assembly.

14. The panel assembly of claim 13 wherein the touch sensor uses a resistive, capacitative, or a stray capacitative method to detect that the display sub-assembly has been touched.

15. The panel assembly of claim 9 wherein the electric charging system includes a rechargeable battery, the display sub-assembly being further configured to display information corresponding to a state of charge of the rechargeable battery.

16. The panel assembly of claim 15 wherein the display sub-assembly is further configured to display information corresponding to a length of time until charging the rechargeable battery is complete.

17. The panel assembly of claim 9 wherein the display sub-assembly is further configured to permit a user to enter information corresponding to the electric charging system.

18. The panel assembly of claim 17 wherein the display sub-assembly is further configured to permit a user to set a start time and a completion time for charging the electric charging system.

19. The panel assembly of claim 9 wherein the display sub-assembly is further configured to display an alert when the electric charging system detects a fault during electric charging.

20. A vehicle assembly having an electrical charging system, the vehicle assembly comprising:
a vehicle body;
a body panel connected to the vehicle body, the body panel having an aperture therethrough;
a display sub-assembly connected to the electrical charging system, the display sub-assembly being configured for illumination, the illumination corresponding to a status of the electric charging system, the display sub-assembly having a periphery configured to generally conform to the aperture, the display sub-assembly being mounted to the body panel such that the display sub-assembly is disposed within the aperture and a surface of the display sub-assembly is substantially flush with a surface of the body panel;
a translucent paint disposed over both the surface of the body panel and the surface of the display sub-assembly.
